(19) United States
(12) Patent Application Publication
(10) Pub. No.: US 2018/0361183 A1
(43) Pub. Date: Dec. 20, 2018

(54) SPRINKLER WITH ACTIVATION MONITORING

(71) Applicants: Obschestvo S Ogranichennoi Otvetstvennostju Fornosovskoe Nauchnoproizvodstvennoe Predpriyatie, Leningradskaja obl (RU); JOB-LIZENZ GMBH & CO. KG., Ahrensburg (DE)

(72) Inventors: Leonid Timofeevich TANKLEVSKI, St. Petersburg (RU); Alexander Valerevich ARAKCHEEV, St. Petersburg (RU); Teschner JURGEN, Hamburg (DE); Bodo Muller, Tornesch (DE)

(21) Appl. No.: 15/777,320

(22) PCT Filed: Dec. 19, 2016
(86) PCT No.: PCT/RU2016/000899

§ 371 Date: May 18, 2018

(30) Foreign Application Priority Data
Nov. 18, 2015 (RU) 2015149575

(51) Int. Cl. A62C 37/11

(52) U.S. Cl. CPC A62C 37/11

(57) ABSTRACT

A sprinkler including a housing having an outlet aperture covered by a shut-off valve, a heat-sensitive destructible element, and an actuation monitoring device. The monitoring device is configured as a current-conducting coating that is applied to a surface of the element. The coating has terminals for connecting to a circuit of a sprinkler status monitoring unit. The element is configured as a hermetic glass bulb filled with a liquid that boils at a sprinkler activation temperature. The terminals are located at one end of the heat-sensitive destructible element and are connected to the coating using clamps that encircle the surface of the element. The coating is applied to the surface using sputter deposition. The applied coating is electrically conductive and allows the bulb to be heated to a boiling temperature of the liquid with which the bulb is filled, while feeding voltage from the sprinkler status monitoring unit.

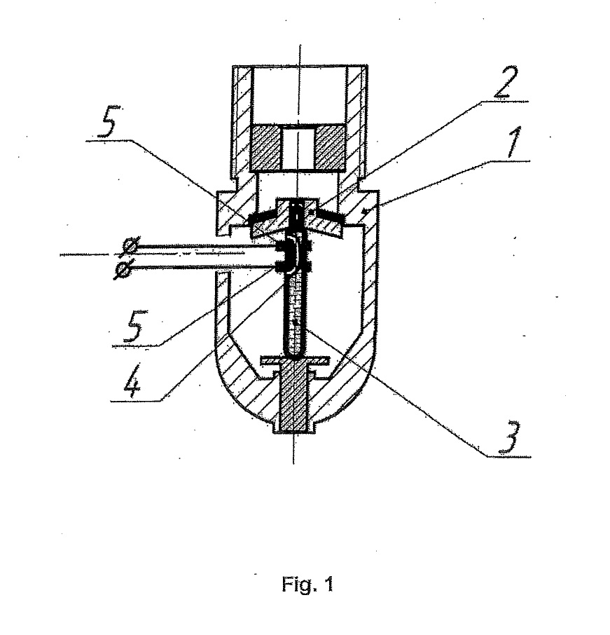

### BACKGROUND

### Technical Field

The proposed invention relates to the field of sprinklers in fire-extinguishing installations and is intended for feeding fire-extinguishing liquid to a source of fire in the case of combustion or burning.

### Background Information

The prior art of the proposed invention is a sprinkler having a monitored start (patent for the invention of the Russian Federation No. 2,379,080 “Sprinkler with Monitored Start”).

The known device comprises a housing, a shut-off valve, a shut-off valve condition monitoring and control unit comprising a heat-sensitive destructible element and a normally closed contact block. The contact block is configured as a shut-off valve and a conical cup located between the shut-off valve and the heat-sensitive destructible element. In the standby mode, a circuit of a sprinkler status monitoring passes through the contact block. In the case where the heat-sensitive destructible element is destroyed after being subjected to the heat flux emitted by the fire, the shut-off valve goes off and the normally closed contact block opens. A break in the circuit of the sprinkler status monitoring signifies activation of the sprinkler.

The disadvantage of the prior art is the low reliability of status monitoring.

The disadvantage of the prior art is caused by the possibility of “sticking” of contacts of the contact block over a long period of operation of the sprinkler and unclosing of the circuit of the sprinkler status monitoring when it is activated in the case of combustion or burning.

### SUMMARY

The purpose of the proposed invention is to improve the reliability of the sprinkler status monitoring.

The essence of the proposed invention is that in a sprinkler comprising a housing having an outlet aperture covered by a shut-off valve, a heat-sensitive destructible element, and an actuation monitoring device, the monitoring device is configured as a current-conducting coating, which is applied to the surface of the heat-sensitive destructible element, with the coating having terminals for connecting to a circuit of a sprinkler status monitoring.

In preferred embodiments of the sprinkler:

the heat-sensitive destructible element is configured as a hermetic glass bulb filled with a liquid, which boils at a sprinkler activation temperature;

the terminals for connecting to a circuit of a sprinkler status monitoring and control unit are connected to the coating using the clamps, which encircle the surface of the element;

the current-conducting coating is applied to the surface of the element using sputter deposition;

the terminals are disposed at one end of the element;

the applied coating is electrically conductive, allowing the bulb to be heated to the boiling temperature of the liquid with which the bulb is filled while feeding voltage from the monitoring and control unit.

Distinctive features of the proposed invention are as follows:

1. The activation monitoring device is configured as a current-conducting coating applied to the surface of the heat-sensitive destructible element—feature 1.

2. The current-conducting coating has terminals for connecting to the circuit of the sprinkler status monitoring and control unit—feature 2.

3. The heat-sensitive destructible element is configured as a hermetic glass bulb filled with the liquid, which boils at the sprinkler activation temperature—feature 3.

4. The terminals for connecting to the circuit of the sprinkler status monitoring and control unit are connected to the coating using the clamps, which encircle the surface of the element—feature 4.

5. The current-conducting coating is applied to the surface of the element using sputter deposition—feature 5.

6. The terminals are disposed at one end of the element—feature 6.

7. The applied coating is electrically conductive, allowing the bulb to be heated to the boiling temperature of the liquid with which the bulb is filled while feeding voltage from the monitoring unit—feature 7.

The summary of the proposed invention is as follows:

Configuring the heat-sensitive destructible element as a current-conducting coating, which is applied to the surface of the heat-sensitive destructible element (feature 1), provided that the coating has terminals for connecting to the circuit of the sprinkler status monitoring (feature 2), allows to increase the reliability of the sprinkler activation monitoring, since in the case of destruction of the heat-sensitive destructible element, due to the thermal effect of the source of fire, the current-conducting coating, which is an element of the status monitoring circuit is also destroyed, wherein the effect of “sticking” of contacts of the status monitoring circuit over a long period of operation of the sprinkler.

Configuring the heat-sensitive destructible element as a hermetic glass bulb filled with the liquid, which boils at the sprinkler activation temperature (feature 3) simplifies the design of the sprinkler, since applying the coating to the surface of the glass bulb is an uncomplicated, industrialized operation.

Connecting the terminals for connecting to the circuit of the sprinkler status monitoring unit to the current-conducting coating using the clamps, which encircle the surface of the element (feature 4) ensures reliable contact of the coating with the line of the circuit of the sprinkler status monitoring.

Applying a current-conducting coating to the surface of the element using sputter deposition (feature 5) is the most technical operation in the mass production of sprinklers.

Disposing the terminals at one end of the element (feature 6) allows simplifying the design of the sprinkler since it's easier to dispose the supply contacts of the monitoring circuit at the one end of the element.

Applying the coating with electrical conductivity, which ensures the heating of the bulb to the boiling temperature of the liquid with which the bulb is filled while feeding voltage from the monitoring and control unit (feature 7), makes it possible to perform, if necessary, the sprinkler's start in addition to its activation monitoring.

### BRIEF DESCRIPTION OF THE DRAWING

The presented draft FIGURE shows a general cross-sectional view of the sprinkler with activation monitoring.

### DETAILED DESCRIPTION

The sprinkler consists of a housing (1), the outlet aperture of which is covered by the shut-off valve (2), the heat-sensitive destructible element (3) configured as the hermetic glass bulb filled with the liquid, which boils at the sprinkler activation temperature, and a start monitoring unit (4) configured as a current-conducting coating applied to the surface of the bulb. The surface of the bulb, in the place of application of the current-conducting coating, is encircled by two clamps (5) for connecting to the sprinkler status monitoring circuit.

The sprinkler operates as follows. In the case of emergence of the fire source in the sprinkler's spraying zone, the sensitive element is being destroyed. The destruction of the element results in the destruction of the applied current-conducting coating and, as a consequence, in the break of the circuit of the sprinkler status monitoring. The break in the circuit signifies activation of the sprinkler.

If it is necessary to perform the forced start of this sprinkler, the monitoring and control unit issues a signal by the voltage allowing the bulb to be heated to the boiling temperature of the liquid with which the bulb is filled.

1. A sprinkler comprising:
a housing having an outlet aperture covered by a shut-off valve;
a heat-sensitive destructible element; and
an actuation monitoring device, wherein the actuation monitoring device is configured as a current-conducting coating that is applied to a surface of the heat-sensitive destructible element, wherein the current-conducting coating has terminals for connecting to a circuit of a sprinkler status monitoring unit.

2. The sprinkler of claim 1, wherein the heat-sensitive destructible element is configured as a hermetic glass bulb filled with a liquid that boils at a sprinkler activation temperature.

3. The sprinkler of claim 1, wherein the terminals for connecting to the circuit of the sprinkler status monitoring unit are connected to the current-conducting coating using the clamps that encircle the surface of the heat-sensitive destructible element.

4. The sprinkler of claim 1, wherein the current-conducting coating is applied to the surface of the heat-sensitive destructible element using sputter deposition.

5. The sprinkler of claim 1, wherein the terminals are disposed at one end of the heat-sensitive destructible element.

6. The sprinkler of claim 2, wherein the applied current-conducting coating is electrically conductive and allows the bulb to be heated to a boiling temperature of the liquid with which the bulb is filled, while feeding voltage from the sprinkler status monitoring unit.
